(19) United States
(12) Patent Application Publication
(10) Pub. No.: US 2019/0026929 A1
(43) Pub. Date: Jan. 24, 2019

(54) ORGANIZING IMAGES AUTOMATICALLY INTO IMAGE GRID LAYOUT

(71) Applicant: MICROSOFT TECHNOLOGY LICENSING, LLC, Redmond, WA (US)

(72) Inventors: Erez KIKIN-GIL, Bellevue, WA (US); Aleta E. C. Bashaw, Kirkland, WA (US); David B. Lee, Sammamish, WA (US)

(73) Assignee: MICROSOFT TECHNOLOGY LICENSING, LLC, Redmond, WA (US)

(21) Appl. No.: 15/653,844

(22) Filed: Jul. 19, 2017

(51) Int. Cl. G06T 11/60; G06T 3/40; G06T 3/00; G06T 7/11

(52) U.S. Cl. CPC G06T 11/60; G06T 3/40; G06T 3/0056; G06K 9/6267; G06T 2207/20132; G06T 2207/10024; G06T 7/11

(57) ABSTRACT

Approaches to organize images automatically into an image grid layout are described. An image processing service initiates operation(s) to organize images upon detecting the images in a container. Next, information associated with the images is identified. The information includes a size, a content, a color palette, a resolution, a creation time, a modification time, a topic based classification, an importance based classification, and/or an emotional based classification. A type of an image grid layout is selected and the images are organized into the image grid layout based on the associated information. A continuous arrangement of the images within the image grid layout is provided by filling a surface area of the image grid layout with the images. A selection from the images are emphasized within the image grid layout based on the associated information.

### BACKGROUND

Information exchange have changed processes associated work and personal environments. Automation and improvements in processes have expanded scope of capabilities offered for personal and business data consumption. With the development of faster and smaller electronics, execution of mass processes at cloud systems have become feasible. Indeed, applications provided by data centers, data warehouses, data workstations have become common features in modern personal and work environments. Image processing service(s) provide a wide variety of applications ranging from image capture, storage, organization, and/or rendering, among others associated with the image(s).

Increasingly, cloud based resources are utilized for variety of services that include image processing services, among others that facilitate processing, classification, and/or rendering, among other operations associated with assets such as images. However, there are currently substantial gaps in dynamically organizing images. Personnel resources are unnecessarily consumed for storing, processing, monitoring, classifying, and/or rendering images. Lack of relevant management solutions to dynamically organize images cause poor management of personnel resources and time when attempting to organize images.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automatically organizing images into an image grid layout. In some examples, two or more images may be detected in a container, by an image processing service, for example. Information associated with the two or more images such as a size, a content, a color palette, a resolution, a creation time, a modification time, a topic based classification, an importance based classification, or an emotional based classification may be determined, for example, from metadata of the images or other resources. The two or more images may then be organized into the image grid layout based on the information associated with the two or more images. A continuous arrangement of the two or more images may be provided within the image grid layout by filling a surface area of the image grid layout with the two or more images and a subset of the two or more images may be emphasized within the image grid layout based on the information associated with the two or more images. The image grid layout may then be provided to a computing device to be presented.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of automatically organizing images into an image grid layout, according to embodiments;

FIG. 2 is a display diagram illustrating example components of an image processing service that organizes images automatically into an image grid layout, according to embodiments;

FIG. 3 is a display diagram illustrating components of a scheme to automatically organize images into an image grid layout, according to embodiments:

FIG. 4 is a display diagram illustrating another example of a scheme to automatically organize images into an image grid layout, according to embodiments;

FIG. 5 is a display diagram illustrating an additional example of a scheme to automatically organize images into an image grid layout, according to embodiments;

FIG. 6 is a simplified networked environment, where a system according to embodiments may be implemented;

FIG. 7 is a block diagram of an example computing device, which may be used to automatically organize images into an image grid layout, according to embodiments; according to embodiments; and

FIG. 7 is a logic flow diagram illustrating a process for automatically organizing images into an image grid layout, according to embodiments.

### DETAILED DESCRIPTION

As briefly described above, an image processing service may organize images automatically into an image grid layout. In an example scenario, the image processing service may detect images in a container. An example container may include a file folder and/or multiple file folders at a local or remote (e.g., cloud-based) data store, among others. Next, information associated with the images may be determined from metadata associated with the images, user input, data associated with images from other data sources (e.g., system directory), and comparable sources. Information associated with the images may include a size, a content, a color palette, a resolution, a creation time, a modification time, a topic based classification, an importance based classification, and/or an emotional based classification associated with the images. A size of the image, as used herein, may refer to a physical size of the image (length and width in distance units), a file size of the image, or a resolution of the image.

The images may be organized into the image grid layout based on the determined information. The image layout grid may include, for example, a tabular grid that includes rows and columns, an ordered grid such that an order of content within the ordered grid is obvious and readable to a user, a uniform grid that leverages alignment and consistent shape or size of the images to convey homogeneity, or a lock-up grid, where the images are processes to fit into a predefined shape in order to convey tight continuity. A continuous arrangement of the images within the image grid layout may also be provided by filling a surface area of the image grid layout with the images. A placement (i.e., arrangement), sizes, ordering, and/or a type of the image grid layout may be selected based on the determined information. For example, a time and/or location of the images' creation (e.g., capture) may be used. In another example, arrangement of grid may be based on content deciphering. An optimal grid may be created based on content knowledge.

In further examples, a selection from the images may be emphasized within the image grid layout based on the associated information. The associated information may be processed to identify the selection that may be highlighted by reshaping and/or applying an effect to the selection compared to a remaining set of the images. For example, an image may be enlarged by a predefined factor compared to another image. The predefined factor may be selected based on display capabilities such that the emphasis is detectable (for example, 10%, 25%, etc.). Other emphasis/deemphasis methods may include change of color composition, shading, etc. The remaining set of the images may also be deemphasized to further enhance the emphasis effect associated with the selection. If the image grid layout is created/finalized at a server, it may be provided to a client device, for example, over one or more networks to be presented to a user.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for organizing images automatically into an image grid layout. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

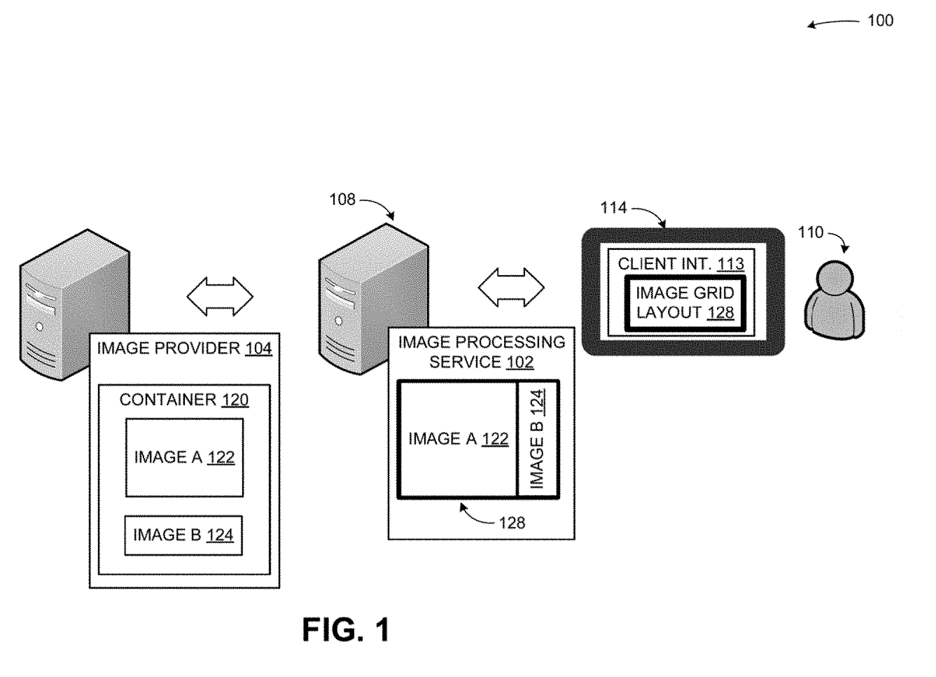

FIG. 1 is a conceptual diagram illustrating examples of automatically organizing images into an image grid layout, according to embodiments.

In a diagram 100, a server 108 may execute (or provide) an image processing service 102. The server 108 may include a physical server providing service(s), application(s), and/or an interface to client devices. A service (such as the image processing service 102) may include an application performing operations in relation to a client application and/or a subscriber, among others. The server 108 may include and/or is part of a workstation, a data warehouse, a data center, and/or a cloud based distributed computing source, among others.

The server 108 may execute the image processing service 102. The image processing service 102 may detect an image A 122 and an image B 124 in a container 120. In an example scenario, the image A 122 and an image B 124 may be hosted and managed by an image provider 104. The image provider 104 may include a cloud based service that provide image storage services. An example of the container 120 may include a file folder, and/or multiple file folders, among others.

Next, information associated with the image A 122 and an image B 124 may be determined. Information associated with the image A 122 and an image B 124 may include a size, a content, a color palette, a resolution, a creation time, a modification time, a topic based classification, an importance based classification, and/or an emotional based classification associated with the image A 122 and an image B 124. The information may be previously provided by a user 110 to designate the image A 122 and the image B 124 with label(s). Alternatively, the information may be automatically provided by a classification provider (such as the image processing service 102) based on attribute(s) associated with the image A 122 and the image B 124 that match the information, among other schemes used to determine the information. Emotion based classification may be determined based on user input or content deciphering, for example. Humorous, dramatic, and similar content may be classified as emotionally effective image content. Similarly, importance based classification may be determined based on importance of content to a particular user or user groups.

The image A 122 and the image B 124 may be organized into the image grid layout 128 based on the associated information. The image grid layout 128 may encapsulate the image A 122 and an image B 124 upon operation(s) that reshape and insert the image A 122 and an image B 124 into a rectangular outline. The image grid layout 128 may encapsulate the image A 122 and an image B 124 in an aesthetically pleasing presentation. A thigh continuity of the image A 122 and the image B 124 may also be provided by filling a surface area of the image grid layout 128 with the image A 122 and the image B 124. The image A 122 and the image B 124 may be reshaped to fill the surface area of the image grid layout 128. In addition, the image A 122 and the image B 124 may be rearranged (such as by changing the orientation associated with the image A 122 and the image B 124) to fill the surface area of the image grid layout 128.

Furthermore, a selection from the images (such as the image A 122) may be emphasized within the image grid layout 128 based on the associated information. The associated information may be analyzed to determine the image A 122 as selected for a highlighting. The image A 122 may be emphasized by reshaping and/or applying an effect to the image A 122 compared to a remaining set of the images (such as the image B 124). For example, the image A 122 may be detected to have a higher resolution compared to the image B 124 (as such, the image A 122 may provide more detail compared to the image B 124). As a result, the image A 122 may be emphasized in a contrast from the image B 124.

The image B 124 may also be deemphasized (such as by reducing a size of the image B 124) to further enhance the emphasis associated with the image A 122 (such as by providing an additional surface area within the image grid layout 128 to enlarge the image A 122). Additionally, the image grid layout 128 may be provided for a presentation.

Furthermore, the image processing service 102 may provide a client interface 113 rendered by a client device 114 to a user 110. The user 110 may initiate operation(s) to render the image A 122 and an image B 124 in an image grid layout 128 and/or view the image grid layout 128 by using the client interface 113. Alternatively, the image processing service 102 may execute operation(s) to render the image grid layout 128 through a client interface rendered by an application (such as an imaging application) executed by the client device 114.

The server 108 may communicate with the client device 114, and/or the image provider 104, through a network. The network may provide wired or wireless communications between network nodes such as the client device 114, the server 108, and/or the image provider 104, among others. Previous example(s) to organize images automatically into the image grid layout 128 are not provided in a limiting sense. Alternatively, the image processing service 102 may provide the image grid layout 128 as a desktop application, a workstation application, and/or a server application, among others. The client interface 113 may also include a client application interacting with the image processing service 102.

The user 110 may interact with the client interface 113 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 108, the image processing service 102, embodiments are not limited to these components or system configurations and can be implemented with other system configuration employing fewer or additional components.

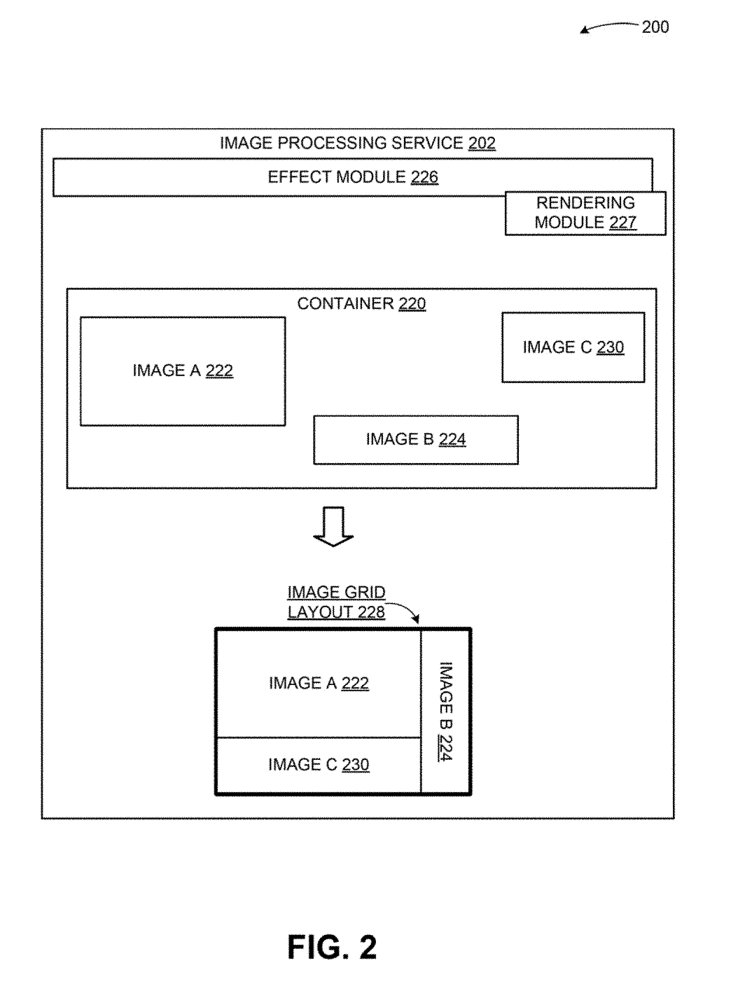

FIG. 2 is a display diagram illustrating example components of an image processing service that organizes images automatically into an image grid layout, according to embodiments.

As illustrated in diagram 200, an effect module 226 of an image processing service 202 may detect a container 220 that includes an image A 222, an image B 224, and an image C 230. In an example scenario, a user may manually select the container 220 for processing the image A 222, the image B 224, and the image C 230 into an image grid layout 228. Alternatively, the image A 222, the image B 224, and the image C 230 may be automatically selected for processing into the image grid layout 228 based on a system configuration, among other automated policies.

In an example scenario, the effect module 226 may determine information associated with the image A 222, the image B 224, and the image C 230. The information may include a size, a content, a color palette, a resolution, a creation time, a modification time, a topic based classification, an importance based classification, and/or an emotional based classification associated with the image A 222, the image B 224, and the image C 230. In an example scenario, the effect module 226 may process metadata associated with the image A 222, the image B 224, and the image C 230 to determine the information. Alternatively, the information may be requested from an image provider that hosts the image A 222, the image B 224, and the image C 230. For example, a data store that hosts the image A 222, the image B 224, and the image C 230 may also store attribute, property, relational, and/or among other information associated with the image A 222, the image B 224, and the image C 230. The effect module 226 may retrieve the image A 222, the image B 224, and the image C 230 along with the associated information from the data store.

The effect module 226 may organize the image A 222, the image B 224, and the image C 230 into the image grid layout 228 based on the associated information. For example, resolution, size, and/or dimension, among other information associated with the image A 222, the image B 224, and the image C 230 may be processed to prioritize a quality and/or an importance classification, among others designated to the images.

A thigh continuity of the image A 222, the image B 224, and the image C 230 may also be provided by filling a surface area of the image grid layout 228 with the image A 222, the image B 224, and the image C 230. The image A 222, the image B 224, and the image C 230 may be reshaped to fill the surface area of the image grid layout 228. In addition, the image A 222, the image B 224, and the image C 230 may be rearranged (such as by changing the orientation associated with the image A 222, the image B 224, and the image C 230) to fill the surface area of the image grid layout 228.

In another example scenario, an interest of the user in an arrangement of the images may be inferred based on preferences of the user that align with the information associated with the images. As such, a selection from the image A 222, the image B 224, and the image C 230 may be emphasized based on the associated information that aligns with the preferences of the user.

A rendering module 227 may provide the image grid layout 228 to the user. The rendering module 227 may provide the image grid layout 228 to an interface associated with the image processing service 202 for a presentation to the user. Alternatively, the rendering module 227 may present the image grid layout 228 to the user through a display device associated with the image processing service 202.

In an example scenario, a number of the images may affect whether the effect module 226 may optimally organize images into the image grid layout 228. For example, the effect module 226 may optimally organize images into the image grid layout 228 if the number of the images is equal to or exceeds five images.

In another example scenario, the effect module 226 may utilize an image recognition scheme to identify person(s) and attribute(s) associated with the person(s) in the image A 222, the image B 224, and/or the image C 230. The image A 222, the image B 224, and/or the image C 230 may be ranked based on the associated attribute(s) such as an age of the person(s) in each of the image A 222, the image B 224, and/or the image C 230. If the age of the person in the image A 222 may be detected as higher than the age of the person in the image B 224 and/or the image C 230 then the image A 222 may be designated as a primary image and the image B 224 and/or the image C 230 may be designated as secondary image(s). As such, the image A 222 may be emphasized compared to the image B 224 and/or the image C 230. Alternatively, classification of the image A 222, the image B 224, and/or the image C 230 may be reversed based on the associated property. One or more properties may be combined to provide a weighted ranking and/or classification associated with the image A 222, the image B 224, and/or the image C 230.

In an additional example scenario, a face recognition scheme may be used to process face(s) of person(s) in the image A 222, the image B 224, and/or the image C 230. If a variation may be detected in a size associated with the face(s) of the person(s) located in the image A 222, the image B 224, and/or the image C 230 then an enlargement and/or a reduction scheme may be applied to the image A 222, the image B 224, and/or the image C 230 to normalize a size associated with face(s) of the person(s) in each of the image A 222, the image B 224, and/or the image C 230. If one of the images has multiple persons then the image may be partitioned to multiple images that includes a single person. The partitioned image(s) may similarly be normalized to achieve a size associate with the face of the person that is similar to the other image(s). Furthermore, image enhancement scheme(s) may also be applied to improve a quality of the face of the person located in the image A 222, the image B 224, and/or the image C 230.

In another example scenario, the effect module 226 may analyze the image A 222, the image B 224, and the image C 230 to designate an emotional based classification to the images. The emotional based classification may be assigned based on facial expression(s) of person(s) in the images or based on other cues such as body language, among others. For example, the effect module 226 may designate the image B 224 and the image C 230 with a similar emotional based classification. However, the image A 222 may be designated with a different emotional based classification. The emotional based classification of the image A 222 may be ranked higher compared to the image based classification designated to the image B 224 and the image C 230. As such image A 222 may be designated as a primary element of the image grid layout 228. The image B 224 and the image C 230 may be designated as secondary elements of the image grid layout 228. The image A 222 may be emphasized compared to the image B 224 and the image C 230 to highlight differences between the image based classification designated to the images.

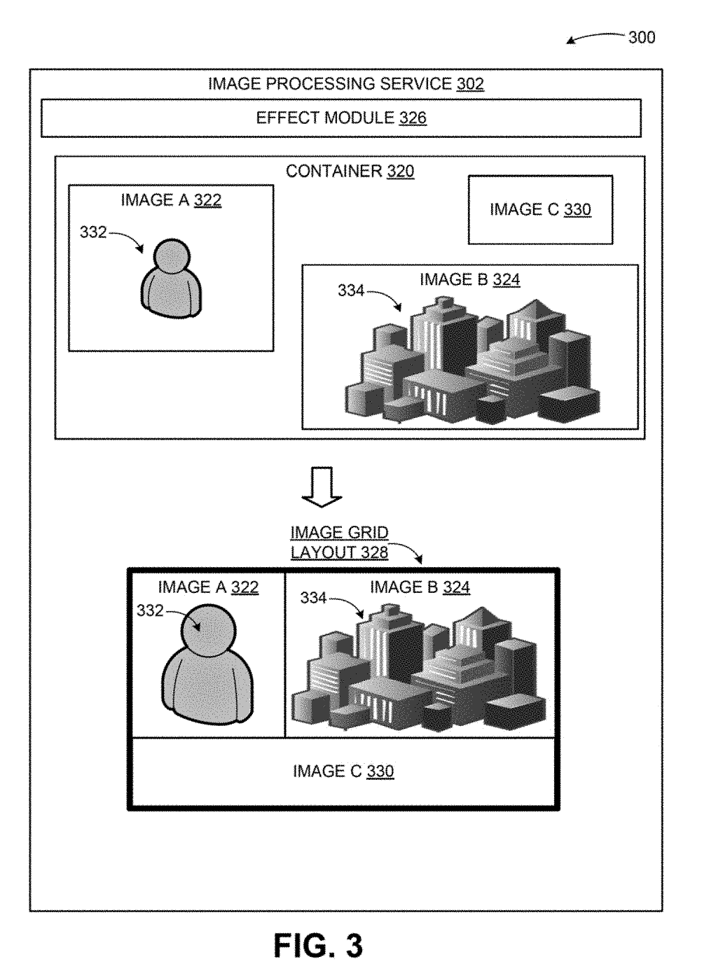

FIG. 3 is a display diagram illustrating components of a scheme to automatically organize images into an image grid layout, according to embodiments.

As shown in a diagram 300, an effect module 326 of an image processing service 302 may process the image A 322, the image B 324, and the image C 330 to produce an image grid layout 328. The image grid layout 328 may emphasize a selection from the image A 322, the image B 324, and the image C 330 based on associated information. The associated information may be processed to rank, classify, arrange, emphasize and/or, deemphasize the image A 322, the image B 324, and/or the image C 330 within the image grid layout 328.

For example, the image A 322, the image B 324, and the image C 330 may be processed to identify a content of the images. An object 332 and an object 334 may be recognized within the content of the image A 322 and the image B 324, respectively. The object 332 may include a portrait of a person. The object 334 may include a landscape. Next, the effect module 326 may remove a section of the image A 322 and the image B 324 (through a cropping operation) that is not associated with the object 332 and the object 334 such as empty space and/or other items around the object 332, the object 334.

Furthermore, the image A 322 and the image B 324 (that is cropped) may be inserted into the image grid layout 328. The object 332 and the object 334 may next be emphasized by increasing a size of the image A 322 and the size of the image B 324. The size of the image A 322 and the image B 324 may be determined based on available space in the image grid layout 328 and/or other factors. For example, the size of the image A 322 and the image B 324 may be determined based on an importance classification associated with the image A 322 and the image B 324 in accordance with a manual designation of the importance classification by the user and/or other stakeholder (who may request the image grid layout 328).

Alternatively, the size of the image A 322 and the image B 324 may be determined based on an automated operation that ranks the image A 322, the image B 324, and/or the image C 330 based on a value associated with the images. The value may be used to rank the image A 322, the image B 324, and/or the image C 330. If the image A 322 and the image B 324 may rank higher than the image C 330 then the image A 322 and the image B 324 may be enlarged to a larger size in contrast to the image C 330.

In an example scenario, information associated with the image A 322 and the image B 324 may be processed to identify objects (332 and 334) that may be designated for an emphasis. The object 332 may be classified as a portrait and the object 334 as a landscape. The classifications may be used to assign an importance based classification to the image A 322 and the image B 324. For example, the image A 322 and the image B 324 may be designated as primary element(s) within the image grid layout 328. In contrast, the image C 330 may be designated as a secondary element within the image grid layout 328. As such, a surface area of the image grid layout 328 may be partitioned to emphasize the image A 322 and the image B 324 by providing a substantially large proportion of the surface area of the image grid layout 328 to the image A 322 and the image B 324 in a contrast to the image C 330. Other effect operation(s) may also be applied to the image A 322 and the image B 324 to emphasize the images. Example of other effect operation(s) to emphasis the images may include a brighten operation, among others.

Furthermore, the image C 330 (designated as a secondary element) may be deemphasized in the image grid layout 328 in a contrast to the image A 322 and the image B 324 that are designated as primary element(s) within the image grid layout 328. The image C 330 may be deemphasized by applying a size reduction operation to the image C 330. Other effect operation(s) may also be applied to the image C 330 to deemphasize the image C 330. Example of other effect operation(s) to deemphasis the image C 330 may include a darken operation, among others.

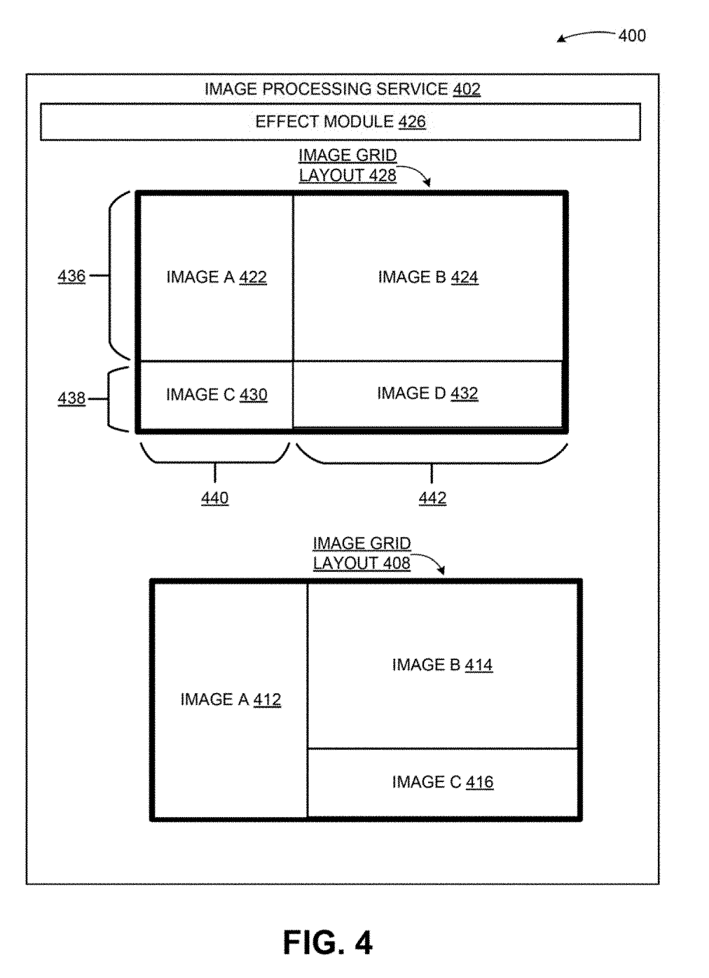

FIG. 4 is a display diagram illustrating another example of a scheme to automatically organize images into an image grid layout, according to embodiments.

As shown in a diagram 400, an effect module 426 of an image processing service 402 may provide an image A 422, an image B 424, image C 430, and an image D 432 in an image grid layout 428. The image grid layout 428 may be an example of a liquid layout in which the image A 422, the image B 424 the image C 430, and the image D 432 may be aligned to rows (436, 438) and/or columns (440, 442). For example, the effect module 426 may designate the image A 422 and the image 424 as primary elements of the image grid layout 428 based on an analysis of associated information. The image C 430 and the image D 432 may be designated as secondary elements of the image grid layout 428 based on the analysis of associated information. The effect module 426 may select a liquid layout to arrange and emphasize the primary elements in a row 436 with a height that is larger compared to a height of a row 438 within the image grid layout 428. As such, the image A 422 and the image B 424 may be resized to enlarge the images in a contrast to the image C 430 and the image D 432 (that are reduced in a size). The emphasis on the image A 422 and the image B 424 may be illustrated by placing the image A 422 and the image B 424 in the row 436 compared to the image C 430 and the image D 432 that are placed in the row 438 with a smaller height than the row 436.

Furthermore, the effect module 426 may align the image A 422, the image B 424 the image C 430, and the image D 432 in columns (440, 442) to comply with the liquid layout arrangement In an example scenario, the image B 424 and the image D 432 may be designated as primary elements of the image grid layout 428 upon an analysis of associated information. The image A 422 and the image C 430 may also be designated as secondary elements of the image grid layout 428 upon the analysis of the associated information. Next, the image B 424 and the image D 432 may be placed in a column 442 with a larger width in a comparison to the image A 422 and the image C 430 placed in a column 440. The larger width of the column 442 may allow the effect module 426 to emphasize the image B 424 and the image D 432 in a comparison to the image A 422 and the image C 430 by enlarging dimension(s) (such as the width) of the image B 424 and the image D 432 in a contrast to the dimension(s) of the image A 422 and the image C 430 (that may be reduced to deemphasize the image A 422 and the image C 430).

In another example scenario, the image A 412, the image B 414, and the image C 416 may be organized in an image grid layout 408. The image grid layout 408 may be an example of a mosaic layout. Dimensions of the image A 412, the image B 414, and the image C 416 may be reduced and/or enlarged to fill a surface area of the image grid layout 408. The dimensions of the image A 412, the image B 414, and the image C 416 may be determined based on a designation associated with the images such as a primary element, a secondary element, and/or a tertiary element, among others. Priority for a higher proportion for the surface area of the image grid layout 408 may be given to the image(s) that are designated as primary element(s) followed by image(s) that are designated as secondary element(s) followed by the image(s) that are designated as tertiary element(s), and so on.

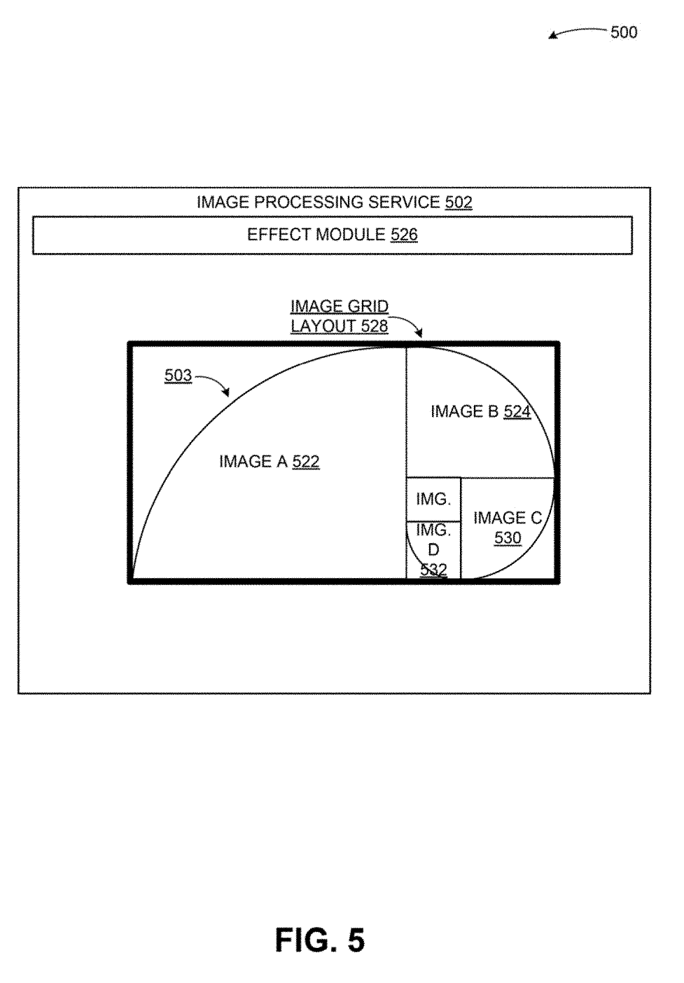

FIG. 5 is a display diagram illustrating an additional example of a scheme to automatically organize images into an image grid layout, according to embodiments.

As shown in a diagram 500, an effect module 526 of an image processing service 502 may organize an image A 522, an image B 524, an image C 530, and an image D 532 into an image grid layout 528 based on a predefined ratio 503. The predefined ratio 503 may be the golden ratio, rule of thirds, or similar ratios that provide an aesthetically pleasing output. The golden ratio provides two values whose ratio is the same as the ratio of their sum to the larger of the two values. The rule of thirds provides that an image may be imagined as divided into nine equal parts by two equally spaced horizontal lines and two equally spaced vertical lines, and that important compositional elements (images in the image grid layout) may be placed along these lines or their intersections.

For example, the effect module 526 may rank the image A 522, the image B 524, the image C 530, and the image D 532 based on associated information. The image A 522 may be designated as a primary element, the image B 524 may be designated as a secondary element, the image C 530 may be designated as a tertiary element, and the image D 532 may be designated as a quaternary element within the image grid layout 528.

Next, the effect module 526 may resize dimensions of the image A 522, the image B 524, the image C 530, and the image D 532 based on the golden ratio 503. For example, a width of the image A 522 such as W1 (514) may be configured with a ratio of approximately 1.618 of a length of the image A 522 such as L1 (512). Subsequently, a dimension of the image B 524 such as W2 (516) may be configured with an equation based on the dimensions of the image A 522. The equation may include W1 (514)−L1 (522)=W2 (516). Alternatively, the dimension of the image B 524 such as W2 (516) may be configured with a ratio of approximately 0.618 of a length of the L1 (512).

Furthermore, a dimension (such as a length or a width) of the image C 530 may be configured with an equation that includes L1 (512)−W2 (516). Alternatively, the dimension of the image C 530 may be configured with a ratio of approximately 0.382 of a length of the L1 (512). Furthermore, a dimension (such as a length or a width) of the image D 532 may be configured with an equation that includes W2 (516)—a length of a dimension of the image C 530. Alternatively, the dimension of the image D may be configured with a ratio of approximately 0.236 of a length of the L1 (512). A remaining set of images may be configured based on an equation subtracting dimensions of the previous two images to determine a dimension of the current image. The dimensions of the image B 524 and the image C 530 and the image D 532 may include a width and a length that are equal.

In another example scenario, the image A 522, the image B 524, the image C 530, and the image D 532 (along with any other image(s)) may be processed with other effect(s) that may produce a visually pleasing arrangement. For example, a normalizing effect such as a black and white operation may be applied to convert the image A 522, the image B 524, the image C 530, and the image D 532 (along with any other image(s)) to grayscale based images. Furthermore, color based effect(s) may be applied to produced images with a uniform color palette range. The image A 522, the image B 524, the image C 530, and the image D 532 (along with any other image(s)) may also be emphasized based on other information associated with the images such as a creation time, a modification time, an importance based classification, a topic based classification, and an emotional based classification associated with the images.

In another example scenario, numerical values in a table may be rendered as images within an image grid layout. The numerical values may be rendered as a size of an associated image and inserted into the image grid layout. Titles and/or other designations associated with the numerical values may also be inserted into the rendered images within the image grid layout.

As discussed above, the image processing service may be employed to perform operations to organize images automatically into an image grid layout. An increased performance and efficiency improvement with the image processing service 102 may occur as a result of automatically processing the image A 522, the image B 524, the image C 530, and the image D 532 (along with any other image(s)) to a visual pleasing arrangement within an image grid layout. Additionally, the image grid layout may emphasize attributes associated with a selection from the image A 522, the image B 524, the image C 530, and the image D 532 (along with any other image(s)) and improve consumption of the information conveyed by the image A 522, the image B 524, the image C 530, and the image D 532 (along with any other image(s)) based operation(s) and process(es) executed by the image processing service 102, and may reduce processor load, increase processing speed, conserve memory, and reduce network bandwidth usage.

Embodiments, as described herein, address a need that arises from a lack of efficiency to organize images automatically into an image grid layout. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Organizing images automatically into an image grid layout may be implemented in configurations employing fewer or additional components in applications and user interfaces. Furthermore, the example schema and components shown in FIG. 1 through 5 and their subcomponents may be implemented in a similar manner with other values using the principles described herein.

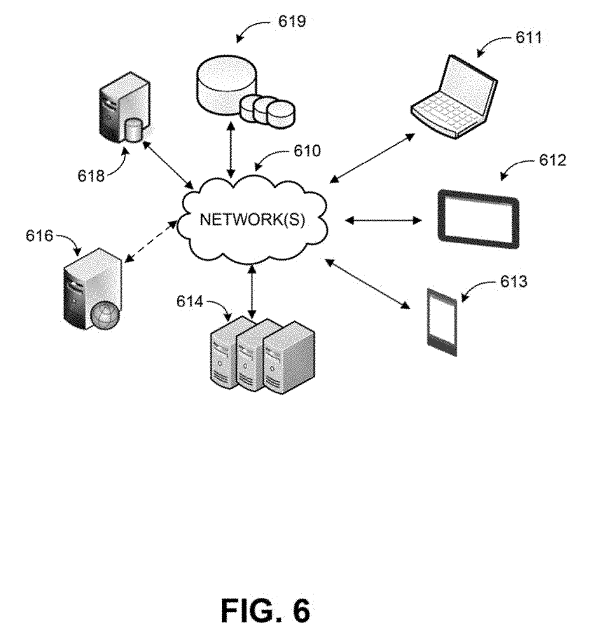

FIG. 6 is an example networked environment, where embodiments may be implemented. An image processing service configured to organize images automatically into an image grid layout may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. An image processing service may detect images in a container. Next, information associated with the images may be determined. The information may include a size, a content, a color palette, a resolution, a creation time, a modification time, a topic based classification, an importance based classification, and/or an emotional based classification. The images may be organized into an image grid layout based on the associated information. A continuous arrangement of the images within the image grid layout may be provided by filling a surface area of the image grid layout with the images. A selection from the images may be emphasized within the image grid layout based on the associated information. Furthermore, the image grid layout may be provided for a presentation. The image processing service may store data associated with the image grid layout in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to organize images automatically into an image grid layout. Furthermore, the networked environments discussed in FIG. 6 are for illustration purposes only. Embodiments are not limited to the example applications, modules, or processes.

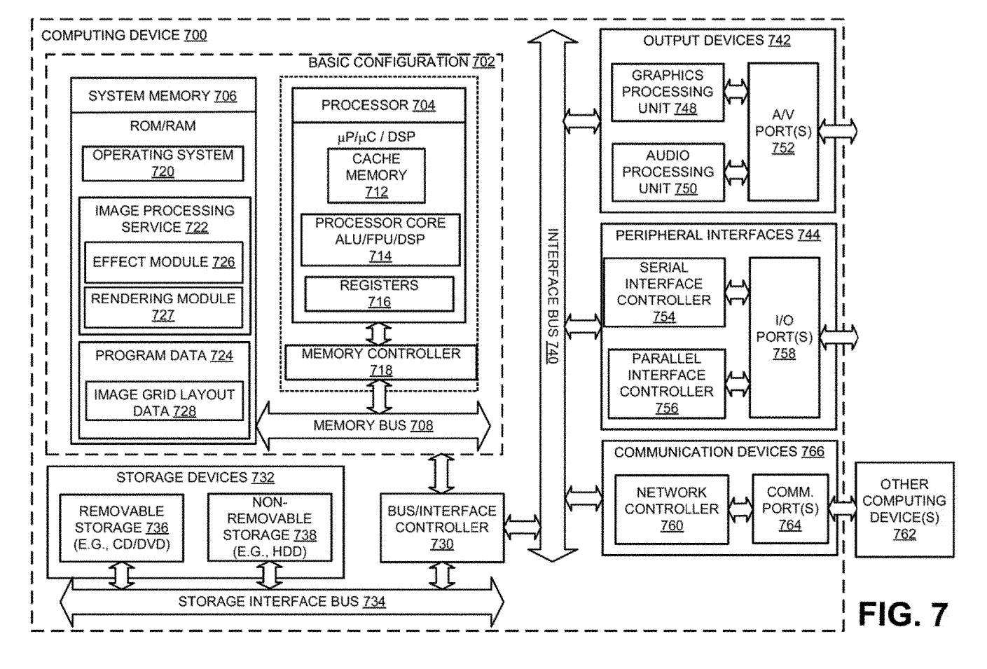

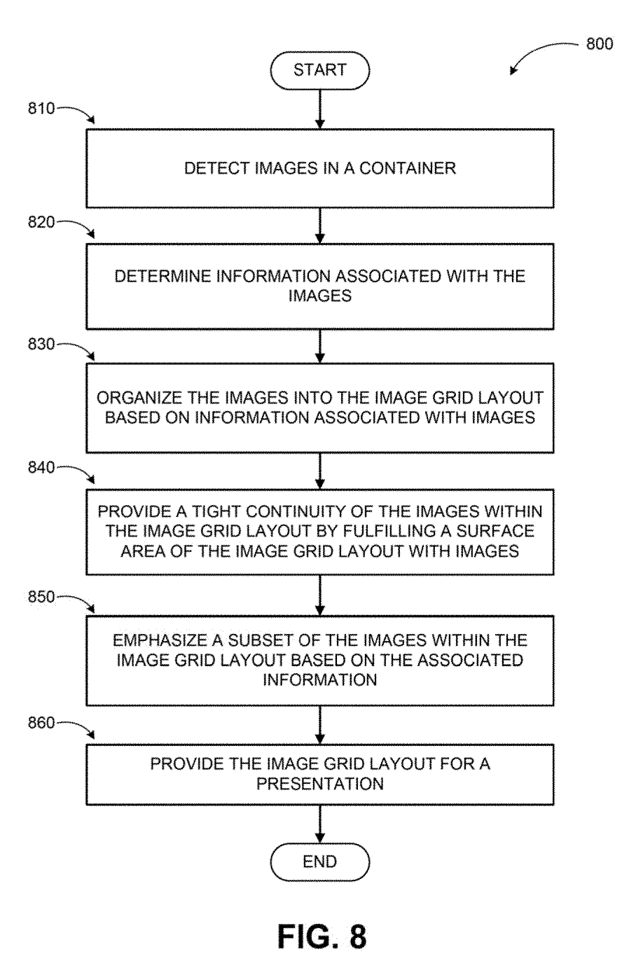

FIG. 7 is a block diagram of an example computing device, which may be used to automatically organize images into an image grid layout, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), a graphics processing unit (GPU), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, an image processing service 722, and a program data 724. The image processing service 722 may include components such as an effect module 726 and a rendering module 727. The effect module 726 and the rendering module 727 may execute the processes associated with the image processing service 722. The effect module 726 may detect images in a container. Next, information associated with the images may be determined. The information may include a size, a content, a color palette, a resolution, a creation time, a modification time, a topic based classification, an importance based classification, and/or an emotional based classification. The images may be organized into an image grid layout based on the associated information. A continuous arrangement of the images within the image grid layout may be provided by filling a surface area of the image grid layout with the images. A selection from the images may be emphasized within the image grid layout based on the associated information. Furthermore, the rendering module may provide the image grid layout for a presentation.

Input to and output out of the image processing service 722 may be transmitted through a communication device 766 that may be communicatively coupled to the computing device 700. The communication device 766 may provide wired and/or wireless communication. The program data 724 may also include, among other data, an image grid layout data 728, or the like, as described herein. The image grid layout data 728 may include information associated with the images, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example of the communication device(s) 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a specialized server, mainframe, or similar computer, which includes any of the above functions. The computing device 700 may also be implemented as a personal computer including both laptop computer and non-laptop computer configurations. Additionally, the computing device 700 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to organize images automatically into an image grid layout. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

FIG. 8 is a logic flow diagram illustrating a process for automatically organizing images into an image grid layout, according to embodiments. Process 800 may be implemented on a computing device, such as the computing device 700 or another system.

Process 800 begins with operation 810, where an image processing service may detect images in a container. An example container may include a file folder, and/or multiple file folders, among others that may be designated for processing the images into an image grid layout. Next, at operation 820, information associated with the images may be determined. Information associated with the images may include a size, a content, a color palette, a resolution, a creation time, a modification time, a topic based classification, an importance based classification, and/or an emotional based classification associated with the images.

At operation 830, the images may be organized into the image grid layout based on the associated information. The image grid layout may include the images that may be reshaped and inserted into a rectangular outline to produce an aesthetically pleasing presentation from the images. At operation 840, a continuous arrangement of the images within the image grid layout may be provided by filling a surface area of the image grid layout with the images. At operation 850, a subset of the images may be emphasized within the image grid layout based on the associated information. The information may be processed to identify a selection from the images that may be highlighted by reshaping and/or applying an effect to the selection compared to a remaining set of the images. At operation 860, the image grid layout may be provided for a presentation.

The operations included in process 800 is for illustration purposes. Organizing images automatically into an image grid layout may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to examples, a means for organizing images automatically into an image grid layout is described. The means may include a means for detecting two or more images in a container; a means for determining information associated with the two or more images, where the information includes one or more of a size, a content, a color palette, a resolution, a creation time, a modification time, a topic based classification, an importance based classification, or an emotional based classification; a means for organizing the two or more images into the image grid layout based on the information associated with the two or more images; a means for providing a continuous arrangement of the two or more images within the image grid layout by filling a surface area of the image grid layout with the two or more images; a means for emphasizing a subset of the two or more images within the image grid layout based on the information associated with the two or more images; and a means for providing the image grid layout to be presented.

According to some examples, a method executed on a computing device to organize images automatically into an image grid layout is described. The method may include detecting two or more images in a container; determining information associated with the two or more images, where the information includes one or more of a size, a content, a color palette, a resolution, a creation time, a modification time, a topic based classification, an importance based classification, or an emotional based classification; organizing the two or more images into the image grid layout based on the information associated with the two or more images; providing a continuous arrangement of the two or more images within the image grid layout by filling a surface area of the image grid layout with the two or more images; emphasizing a subset of the two or more images within the image grid layout based on the information associated with the two or more images; and providing the image grid layout to be presented.

According to other examples, the two or more images may be arranged within one or more substructures within the image grid layout, where the substructures include one or more of a row, a column, or a cell. The method may also include designating a first image from the two or more images as a primary element and a second image from the two or more images as a secondary element of the image grid layout based on the information associated with the two or more images; and emphasizing the first image to contrast with the second image within the image grid layout. Emphasizing the first image to contrast with the second image may include increasing one or more of, a color, an opacity, a blur, a focus, or an image filter associated with the first image to contrast with the second image within the image grid layout. Emphasizing the first image to contrast with the second image may also include applying an enlargement effect to increase a dimension of the first image by a predefined factor to contrast with the second image.

According to further examples, designating the first image from the two or more images as the primary element may include detecting a resolution of the first image to exceed or to be equal a resolution quality threshold; and designating the first image as the primary element of the image grid layout. Designating the second image from the two or more images as the secondary element may include detecting a resolution of the second image to be less than the resolution quality threshold; and designating the second image as the secondary element. Organizing the two or more images into the image grid layout may include identifying an object by processing a content of a first image from the two or more images and removing a section of the first image that is not associated with the object by applying a cropping operation on the first image in relation to the object. Organizing the two or more images into the image grid layout may include organizing the two or more images in a tabular grid, where the tabular grid comprises rows and columns; organizing the two or more images in an ordered grid such that an order of content within the ordered grid is obvious and readable to a user; organizing the two or more images in a uniform grid, where the uniform grid leverages alignment and consistent shape or size of the images to convey homogeneity; or organizing the two or more images in a lock-up grid, where the two or more images are processes to fit into a predefined shape in order to convey tight continuity. The method may further include resizing the two or more images based on a numerical value assigned to each of the two or more images scaled in proportion to the surface area of the image grid layout, where the numerical value assigned to each of the two or more images represents a percentage of each image within the surface area of the image grid layout. The method may also include computing a ratio from the numerical value assigned to each of the two or more images and a total value of the numerical values assigned to all of the two or more images; and normalizing a size of each of the two or more images based on the ratio.

According to other examples, a server configured to organize images automatically into an image grid layout is described. The server may include a communication device configured to facilitate communication between an image processing service and one or more client devices; a memory configured to store instructions; and a processor coupled to the memory and the communication device, the processor executing the image processing service in conjunction with the instructions stored in the memory. The image processing service may include an effect module configured to detect two or more images in a container; determine information associated with the two or more images, where the information includes one or more of a size, a content, a color palette, a resolution, a creation time, a modification time, a topic based classification, an importance based classification, or an emotion based classification; designate a first image from the two or more images as a primary element and a second image from the two or more images as a secondary element based on the information; and organize the two or more images into the image grid layout using the information by providing a continuous arrangement of the two or more images within the image grid layout by filling a surface area of the image grid layout with the two or more images; and emphasizing the first image to contrast with the second image within the image grid layout. The image processing service may also include a rendering module configured to provide, through the communication device, the image grid layout to be presented.

According to some examples, the effect module may be further configured to organize the two or more images into the image grid layout based on a placement associated with a particular ratio, where the first image is placed before the second image in the placement associated with the particular ratio. The effect module may also be configured to organize the two or more images into the image grid layout by selecting a type of the image grid layout and an order of the images based on one or more of a creation time, an initial order, or content deciphering or the two or more images. The effect module may be further configured to organize a first subset and a second subset of the two or more images within the image grid layout based on a content associated with each of the first subset and the second subset of the two or more images; and emphasize the first subset of the two or more images to contrast with the second subset of the two or more images based on the associated content.

According to yet other examples, the effect module may be further configured to group a subset of the two or more images within the image grid layout based on a shared similar attribute; and emphasize the grouped subset of the two or more images based on the shared similar attribute to contrast with a remaining subset of the two or more images. The shared similar attribute may include one or more of the color palette, the creation time, the modification time, a content location, a creation location, a theme, a shape, or a typology associated with the grouped subset of the two or more images. The effect module may also be configured to apply a uniformity scheme to normalize the two or more images within the image grid layout, where the uniformity scheme includes one or more of a saturation reduction scheme, a tint application scheme, a luminosity normalization scheme, an opacity normalization scheme, a size normalization scheme, or a shape normalization scheme.

According to further examples, a computer-readable memory device with instructions stored thereon to organize images automatically into an image grid layout is described. The instructions may include detecting two or more images in a container; determining information associated with the two or more images, where the information includes one or more of a size, a content, a color palette, a resolution, a creation time, a modification time, a topic based classification, an importance based classification, or an emotion based classification; designating a first image from the two or more images as a primary element and a second image from the two or more images as a secondary element based on the information; selecting a type of the image grid layout based on the information; organizing the image grid layout by providing a continuous arrangement of the two or more images within the image grid layout by filling a surface area of the image grid layout with the two or more images and emphasizing the first image to contrast with the second image within the image grid layout; and providing the image grid layout to be presented.

According to other examples, the instructions may also include deciphering content of the two or more images; and optimizing an order and a size of each image within the image grid layout based on information obtained from the deciphered content of the two or more images.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to organize images automatically into an image grid layout, the method comprising:
detecting two or more images in a container;
determining information associated with the two or more images, wherein the information includes one or more of a size, a content, a color palette, a resolution, a creation time, a modification time, a topic based classification, an importance based classification, or an emotional based classification;
organizing the two or more images into the image grid layout based on the information associated with the two or more images;
providing a continuous arrangement of the two or more images within the image grid layout by filling a surface area of the image grid layout with the two or more images;
emphasizing a subset of the two or more images within the image grid layout based on the information associated with the two or more images; and
providing the image grid layout to be presented.

2. The method of claim 1, wherein the two or more images are arranged within one or more substructures within the image grid layout, wherein the substructures include one or more of a row, a column, or a cell.

3. The method of claim 1, further comprising:
designating a first image from the two or more images as a primary element and a second image from the two or more images as a secondary element of the image grid layout based on the information associated with the two or more images; and
emphasizing the first image to contrast with the second image within the image grid layout.

4. The method of claim 3, wherein emphasizing the first image to contrast with the second image comprises:
modifying one or more of a color composition, an opacity, a blur, a focus, or an image filter associated with the first image to contrast with the second image within the image grid layout.

5. The method of claim 3, wherein emphasizing the first image to contrast with the second image comprises:
applying an enlargement effect to increase a dimension of the first image by a predefined factor to contrast with the second image.

6. The method of claim 3, wherein designating the first image from the two or more images as the primary element comprises:
detecting a resolution of the first image to exceed or to be equal a resolution quality threshold; and
designating the first image as the primary element of the image grid layout.

7. The method of claim 6, wherein designating the second image from the two or more images as the secondary element comprises:
detecting a resolution of the second image to be less than the resolution quality threshold; and
designating the second image as the secondary element.

8. The method of claim 1, wherein organizing the two or more images into the image grid layout comprises:
identifying an object by processing a content of a first image from the two or more images; and
removing a section of the first image that is not associated with the object by applying a cropping operation on the first image in relation to the object.

9. The method of claim 1, wherein organizing the two or more images into the image grid layout comprises one of:
organizing the two or more images in a tabular grid, wherein the tabular grid comprises rows and columns;
organizing the two or more images in an ordered grid such that an order of content within the ordered grid is obvious and readable to a user;
organizing the two or more images in a uniform grid, wherein the uniform grid leverages alignment and consistent shape or size of the images to convey homogeneity; and
organizing the two or more images in a lock-up grid, wherein the two or more images are processes to fit into a predefined shape in order to convey tight continuity.

10. The method of claim 1, further comprising:
resizing the two or more images based on a numerical value assigned to each of the two or more images scaled in proportion to the surface area of the image grid layout, wherein the numerical value assigned to each of the two or more images represents a percentage of each image within the surface area of the image grid layout.

11. The method of claim 10, further comprising:
computing a ratio from the numerical value assigned to each of the two or more images and a total value of the numerical values assigned to all of the two or more images; and
normalizing a size of each of the two or more images based on the ratio.

12. A server configured to organize images automatically into an image grid layout, the server comprising:
a communication device configured to facilitate communication between an image processing service and one or more client devices;
a memory configured to store instructions; and
a processor coupled to the memory and the communication device, the processor executing the image processing service in conjunction with the instructions stored in the memory, wherein the image processing service includes:
an effect module configured to:
detect two or more images in a container;
determine information associated with the two or more images, wherein the information includes one or more of a size, a content, a color palette, a resolution, a creation time, a modification time, a topic based classification, an importance based classification, or an emotional based classification;
designate a first image from the two or more images as a primary element and a second image from the two or more images as a secondary element based on the information; and
organize the two or more images into the image grid layout using the information by:
providing a continuous arrangement of the two or more images within the image grid layout by filling a surface area of the image grid layout with the two or more images; and
emphasizing the first image to contrast with the second image within the image grid layout; and
a rendering module configured to:
provide, through the communication device, the image grid layout to be presented.

13. The server of claim 12, wherein the effect module is further configured to:
organize the two or more images into the image grid layout based on a placement associated with a particular ratio, wherein the first image is placed before the second image in the placement associated with the particular ratio.

14. The server of claim 12, wherein the effect module is further configured to:
organize the two or more images into the image grid layout by selecting a type of the image grid layout and an order of the images based on one or more of a creation time, an initial order, or content deciphering of the two or more images.

15. The server of claim 12, wherein the effect module is further configured to:
organize a first subset and a second subset of the two or more images within the image grid layout based on a content associated with each of the first subset and the second subset of the two or more images; and
emphasize the first subset of the two or more images to contrast with the second subset of the two or more images based on the associated content.

16. The server of claim 12, wherein the effect module is further configured to:
group a subset of the two or more images within the image grid layout based on a shared similar attribute; and
emphasize the grouped subset of the two or more images based on the shared similar attribute to contrast with a remaining subset of the two or more images.

17. The server of claim 16, wherein the shared similar attribute includes one or more of the color palette, the creation time, the modification time, a content location, a creation location, a theme, a shape, or a typology associated with the grouped subset of the two or more images.

18. The server of claim 12, wherein the effect module is further configured to:
apply a uniformity scheme to normalize the two or more images within the image grid layout, wherein the uniformity scheme includes one or more of a saturation reduction scheme, a tint application scheme, a luminosity normalization scheme, an opacity normalization scheme, a size normalization scheme, or a shape normalization scheme.

19. A computer-readable memory device with instructions stored thereon to organize images automatically into an image grid layout, the instructions comprising:
detecting two or more images in a container;
determining information associated with the two or more images, wherein the information includes one or more of a size, a content, a color palette, a resolution, a creation time, a modification time, a topic based classification, an importance based classification, or an emotional based classification;
designating a first image from the two or more images as a primary element and a second image from the two or more images as a secondary element based on the information;
selecting a type of the image grid layout based on the information;
organizing the image grid layout by providing a continuous arrangement of the two or more images within the image grid layout by filling a surface area of the image grid layout with the two or more images and emphasizing the first image to contrast with the second image within the image grid layout; and
providing the image grid layout to be presented.

20. The computer-readable memory device of claim 19, wherein the instructions further comprise:
deciphering content of the two or more images; and
optimizing an order and a size of each image within the image grid layout based on information obtained from the deciphered content of the two or more images.
